(19) United States
(12) Patent Application Publication
(10) Pub. No.: US 2022/0091534 A1
(43) Pub. Date: Mar. 24, 2022

(54) IMAGE ALIGNMENT BY DETECTING CHANGE IN POSITION OF BEAM

(71) Applicant: Hewlett-Packard Development Company, L.P., Spring, TX (US)

(72) Inventors: Hyoungil Kim, Pangyo (KR); Jaeil Yu, Suwon (KR); Sungdae Kim, Suwon (KR); Sangbum Woo, Pangyo (KR); Ji Young Byun, Pangyo (KR); Yong Ho You, Pangyo (KR)

(73) Assignee: Hewlett-Packard Development Company, L.P., Spring, TX (US)

(21) Appl. No.: 17/417,032

(22) PCT Filed: Jan. 7, 2020
(86) PCT No.: PCT/US2020/012452

§ 371 Date: Jun. 21, 2021

(30) Foreign Application Priority Data
Jun. 14, 2019 (KR) 10-2019-0071091

(51) Int. Cl. G03G 15/043; H04N 1/047

(52) U.S. Cl. CPC G03G 15/043; H04N 2201/0448; H04N 1/047

(57) ABSTRACT

An example operating method of an image forming apparatus includes detecting a position change of a beam with respect to a certain color in a main scanning direction, based on a change in a detection time at which the beam with respect to the certain color is detected by a beam detecting apparatus in the main scanning direction, detecting a position change of the beam with In respect to the certain color in a sub-scanning direction, based on a change in a detection time at which the beam with respect to the certain color is detected by the beam detecting apparatus in the sub-scanning direction, and correcting a value of at least one parameter used for alignment between an image of a reference color and an image of the certain color, based on the position changes of the beam in the main scanning direction and the sub-scanning direction.

### BACKGROUND

An image forming apparatus may form an image on a recording medium, such as paper, through an image forming process of charging, exposing, developing, transferring, and fusing. For example, an image forming apparatus may form a visible toner image on a photoconductor by supplying toner to an electrostatic latent image formed on a photoconductor, transfer the toner image to a recording medium, and fuse the transferred toner image on the recording medium to print the image on the recording medium.

### BRIEF DESCRIPTION OF THE DRAWINGS

FIG. 1 is a view for describing a schematic structure and operation of an image forming apparatus, according to an example;

FIG. 2 is a flowchart for describing an operating method of an image forming apparatus, according to an example;

FIG. 3 is a view for describing a beam detecting apparatus located in an image forming apparatus, according to an example;

FIG. 4 is a view for describing a position of a beam, the position being changed in a main scanning direction, according to a change of a lens, according to an example;

FIG. 5 is a flowchart for describing a method of detecting a position change of a beam in a main scanning direction in an image forming apparatus, according to an example;

FIG. 6 is a view for describing a change in a detection time detected by a beam detecting apparatus, when a position of the beam is changed in a main scanning direction, according to an example;

FIG. 7 is a view for describing a method of calculating an amount of change of a start position of a valid image area of a certain color against a reference color in a main scanning direction and a change amount of a width of the valid image area of the certain color against the reference color, according to an example;

FIG. 8 is a view for describing a position of a beam, the position being changed in a sub-scanning direction, according to rotation of a mirror, according to an example;

FIG. 9 is a flowchart for describing a method of detecting a position change of a beam in a sub-scanning direction, in an image forming apparatus, according to an example;

FIG. 10 is a view for describing a beam detecting apparatus to detect a beam in a sub-scanning direction and an output signal of the beam detecting apparatus, according to an example;

FIG. 11 is a view for describing a change in a detection time detected by a beam detecting apparatus, when a position of a beam is changed in a sub-scanning direction, according to an example;

FIG. 12 is a view for describing a method of calculating an amount of change of a start position of a valid image area of a certain color against a reference color in a sub-scanning direction and an amount of change of a distortion of the valid image area of the certain color against the reference color, according to an example; and

FIG. 13 is a block diagram illustrating a structure of an image forming apparatus, according to an example.

### DETAILED DESCRIPTION OF EXAMPLES

Various examples will be described with reference to the accompanying drawings. The examples described below may be modified and implemented in various different forms. Like reference numerals in the drawings denote like elements, and thus a repetitive description may be omitted.

An “image forming apparatus” may include any type of apparatus capable of performing an image forming job, such as a printer, a copier, a scanner, a fax machine, a multi-function printer (MFP), a display apparatus, or the like.

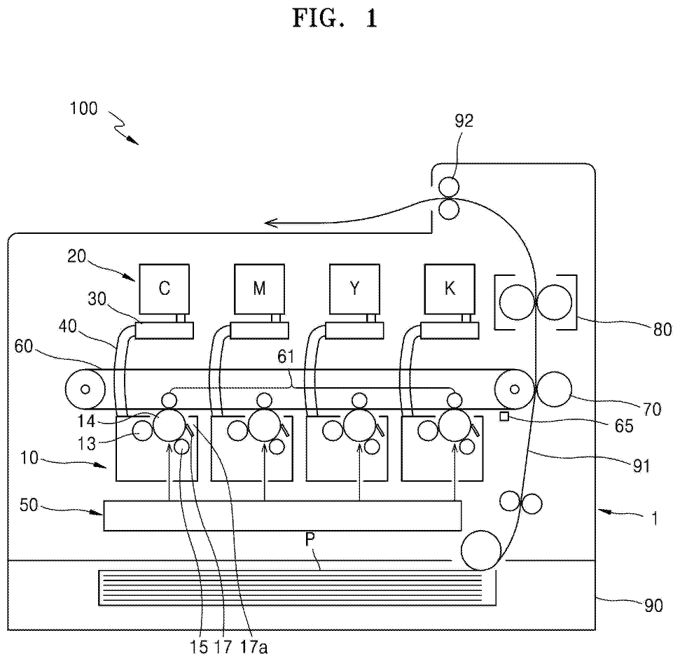

FIG. 1 is a view for describing a schematic structure and operation of an image forming apparatus, according to an example.

Referring to FIG. 1, an image forming apparatus 100 may include a plurality of developing devices 10, a plurality of developing agent cartridges 20, a developing agent supply unit 30, an exposure unit 50, a transfer unit, and a fusing unit 80.

The plurality of developing devices 10 may form toner images having a cyan color C, a magenta color M, a yellow color Y, and a black color K. The plurality of developing agent cartridges 20 may respectively accommodate developing agents having the cyan, magenta, yellow, and black colors C, M, Y, and K to be supplied to the plurality of developing devices 10. The developing agent supply unit 30 may supply a developing agent to the developing device 10 through a supply pipe 40.

The developing device 10 may include a photoconductor 14, on a surface of which an electrostatic latent image is formed, and a developing roller 13 to supply the developing agent to the electrostatic latent image via a developing bias voltage to develop a visible toner image. A photosensitive drum may be an example of the photoconductor 14, on the surface of which the electrostatic latent image is formed, and may include an organic photoconductor (OPC) including a conductive metal pipe and a photosensitive layer formed on an outer circumferential surface of the conductive metal pipe. A charging roller 15 may be an example of a charger to charge the photoconductor 14 to have a uniform surface potential.

The developing device 10 may further include a charging roller cleaner (not shown) to remove a developing agent or a foreign material, such as dust, etc., attached to the charging roller 15, a cleaning member 17 to remove the developing agent remaining on a surface of the photoconductor 14 after an intermediate transfer process, and a regulation member to regulate the amount of the developing agent supplied to a developing area facing the photoconductor 14 and the developing roller 13. A waste developing agent may be accommodated in a waste developing agent container 17a.

The exposure unit 50 may form an electrostatic latent image on the photoconductor 14 by irradiating light, modulated in correspondence to image information, onto the photoconductor 14, and may include a laser scanning unit (LSU) using a laser diode as a light source, a light-emitting diode (LED) exposure unit using an LED as a light source, or the like.

The transfer unit may transfer the toner image formed on the photoconductor 14 to a recording medium P. For example, the transfer unit may include an intermediate transfer medium 60, an intermediate transfer roller 61, and a transfer roller 70.

Developed toner images may be sequentially and intermediately transferred to the intermediate transfer medium 60. The recording medium P loaded in a source paper unit 90 that is coupled to a body 1 of the image forming apparatus 100 may be transported along a source paper path 91 to a location between the transfer roller 70 and the intermediate transfer medium 60. The toner image intermediately transferred onto the intermediate transfer medium 60 may be transferred to the recording medium P by a transfer bias voltage applied to the transfer roller 70. When the recording medium P passes through the fusing unit 80, the toner image may be fused to the recording medium P due to heat and pressure. The recording medium P on which the fusing is completed may be discharged through a discharge roller 92.

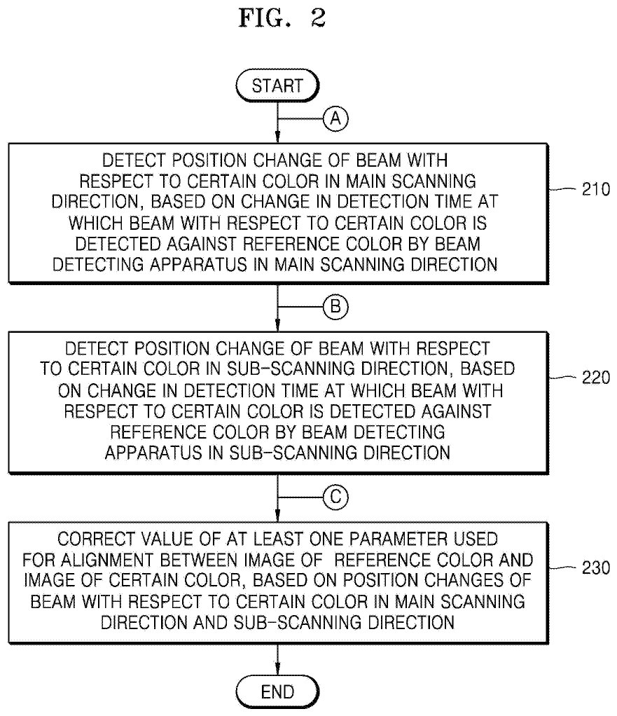

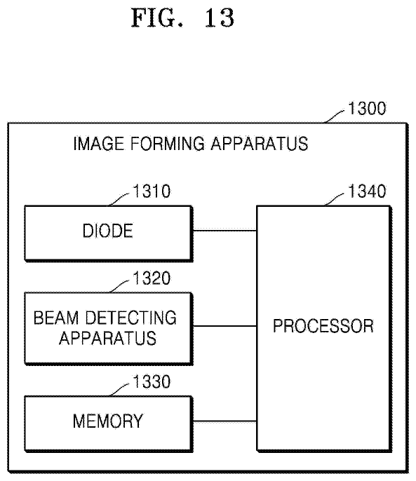

FIGS. 2 through 12 describe an example operating method of the image forming apparatus 100, the operating method including detecting a position change of a beam irradiated from the exposure unit 50 in a main scanning direction or a sub-scanning direction and correcting distortion of an image based on a result of the detection. The image forming apparatus 100 described in FIGS. 2 through 12 may correspond to an image forming apparatus described in FIG. 13.

FIG. 2 is a flowchart for describing an operating method of an image forming apparatus, according to an example.

Referring to FIG. 2, the image forming apparatus 100 may detect a position change of a beam with respect to a certain color in a main scanning direction, based on a change in a detection time at which the beam with respect to the certain color is detected by a beam detecting apparatus included in the image forming apparatus 100 in the main scanning direction, against a reference color in operation 210.

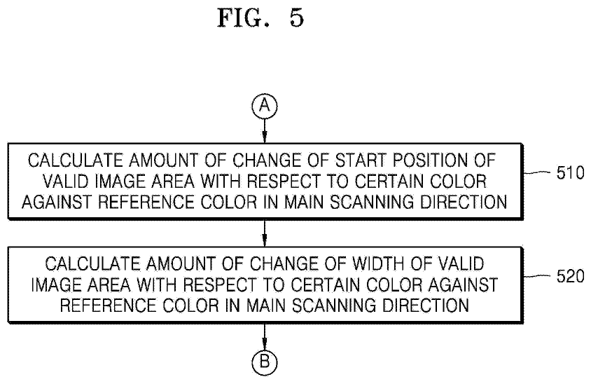

For example, the image forming apparatus 100 may calculate the amount of change of a start position of a valid image area with respect to the certain color in the main scanning direction against the reference color, and the amount of change of a width of the valid image area, based on the change in the detection time at which the beam is detected in the main scanning direction. Here, the start position of the valid image area may be indicated as a position apart from the reference position by a certain offset. The amount of change in the start position of the valid image area may be the amount of change in the offset. An example method of calculating the amount of change in the start position of the valid image area with respect to the certain color against the reference color and the amount of change in the width of the valid image area will be described in FIGS. 5 through 7.

In operation 220, the image forming apparatus 100 may detect a position change of a beam with respect to a certain color in a sub-scanning direction, based on a change of a detection time at which the beam with respect to the certain color is detected by the beam detecting apparatus in the sub-scanning direction, against a reference color.

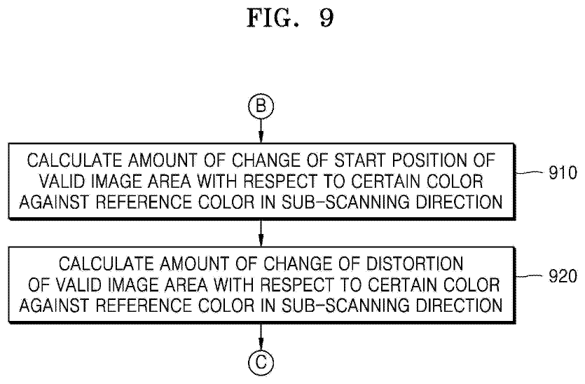

For example, the image forming apparatus 100 may calculate the amount of change of a start position of a valid image area with respect to the certain color in the sub-scanning direction against the reference color, and the amount of change of a distortion of the valid image area, based on the change in the detection time at which the beam is detected in the sub-scanning direction. An example method of calculating the amount of change in the start position of the valid image area with respect to the certain color against the reference color and the amount of change in the distortion of the valid image area will be described in FIGS. 9 through 12.

In operation 230, the image forming apparatus 100 may correct a value of at least one parameter used to perform alignment between an image of the reference color and an image of the certain color, based on the position changes of the beam with respect to the certain color in the main scanning direction and the sub-scanning direction.

For example, the image forming apparatus 100 may correct at least one value of a scan time point of the beam, a frequency of the beam, or an angle of a lens to transmit the beam to the OPC drum, based on the position changes of the beam with respect to the certain color in the main scanning direction and the sub-scanning direction.

The image forming apparatus 100 may correct the value of the at least one parameter used to perform the alignment between the image of the reference color and the image of the certain color, based on the amount of the position change of the beam, without printing a pattern for image alignment on the intermediate transfer medium. Thus, the image forming apparatus 100 may form an image without distortion between colors. That is, the image forming apparatus 100 may increase the image quality, without an additional operation of printing a pattern for image alignment.

The image forming apparatus 100 may perform the operation of detecting the position change of the beam before an image forming job or during the image forming job. The image forming apparatus 100 may detect the position change of the beam during the image forming job and thus data used to perform the image alignment may be stored in an accumulative manner and the number of data samples may be increased to minimize the measuring error.

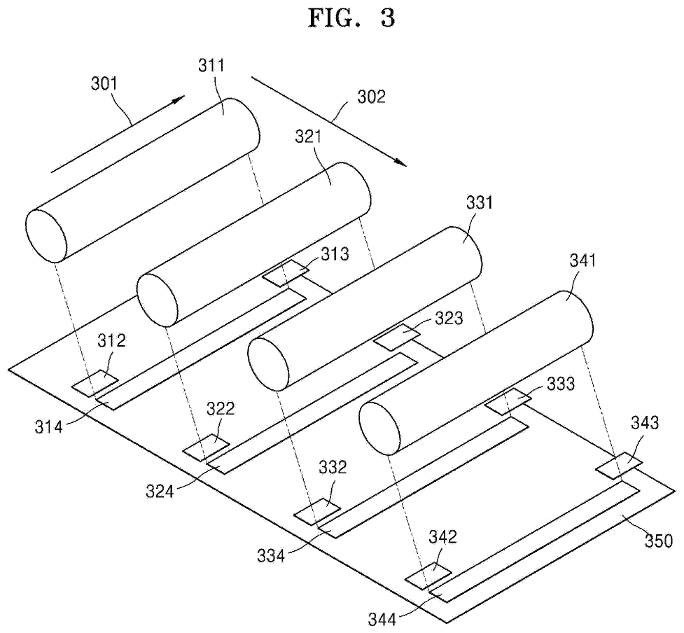

FIG. 3 is a view for describing a beam detecting apparatus located in an image forming apparatus, according to an example.

Referring to FIG. 3, a developing device may include a photoconductor, a developing roller, and a charging roller. For example, the photoconductor may be an OPC drum. As illustrated in FIG. 3, there may be a plurality of OPC drums 311, 321, 331, and 341. For example, when developing agents used in the image forming apparatus 100 have four colors including cyan C, magenta M, yellow Y, and black K, there may be four OPC drums corresponding to the four colors, respectively.

The exposure unit may include a laser scanning unit (LSU) 350 using a laser diode as a light source. As illustrated in FIG. 3, the LSU 350 may irradiate beams through output portions 314, 324, 334, and 344 of the beams to the OPC drums 311, 321, 331, and 341 so that electrostatic latent images may be formed on the OPC drums 311, 321, 331, and 341.

Each beam detecting apparatus may include a first sensor to detect a beam in a main scanning direction 301 indicating a scan direction of an image forming job and a second sensor to detect a beam in a sub-scanning direction 302 indicating a progress direction of the image forming job. For example, each of the first sensor and the second sensor may include a photo diode (PD) sensor, a linear charge coupled device (CCD) sensor, or the like.

As illustrated in FIG. 3, beam detecting apparatuses 312, 313, 322, 323, 332, 333, 342, and 343 may respectively be arranged between arrays of the OPC drums 311, 321, 331, and 341 with respect to the plurality of colors and the LSU 350. Also, the beam detecting apparatuses 312, 313, 322, 323, 332, 333, 342, and 343 may be arranged at a start position and an end position of a valid image area of the OPC drums 311, 321, 331, and 341, respectively. Here, the start position of the valid image area may be the right side based on the sub-scanning direction and the end position of the valid image area may be the left side based on the sub-scanning direction. The beam detecting apparatuses 312, 313, 322, 323, 332, 333, 342, and 343 may be arranged at outer edges around the valid image areas of the OPC drums 311, 321, 331, and 341, respectively.

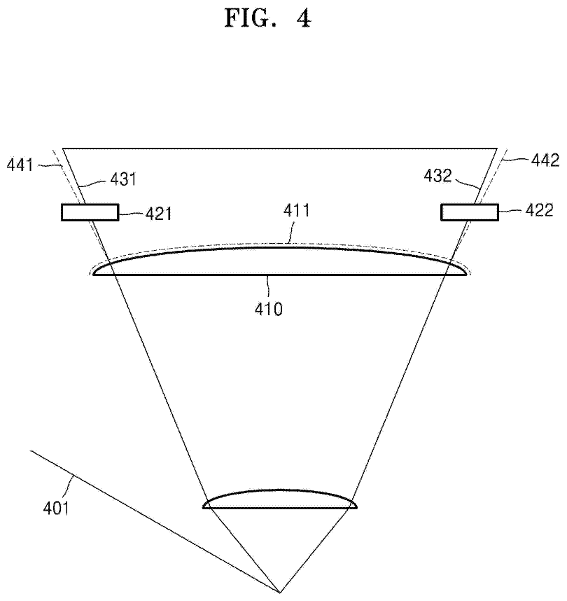

FIG. 4 is a view for describing a position of a beam, the position being changed in a main scanning direction, according to a change in a lens, according to an example.

Referring to FIG. 4, the LSU in the image forming apparatus 100 may be deformed, for example due to a change of an external temperature. Here, the LSU may correspond to the exposure unit 50 of FIG. 1. When the LSU is deformed, the position of the beam irradiated from the LSU may be changed. When the position of the beam is changed, a color distortion may occur in an image formed by the image forming apparatus 100.

For example, the lens in the LSU may be expanded or deformed due to the change of the external temperature. Also, a frame of the LSU for determining positions of a mirror and the lens may be deformed.

As illustrated in FIG. 4, a lens 410 may be expanded due to a change of an external temperature. The lens 410 may be expanded to an area indicated by dashed line 411. When the lens 410 is expanded to the portion indicated by the dashed line 411, previous positions 431 and 432 of the beam may be changed to positions 441 and 442 of the beam that are more refracted toward the outside than the previous positions 431 and 432 of the beam.

The beam detecting apparatus in the image forming apparatus 100 may detect the position change of the beam in the main scanning direction, based on a change in a detection time at which the beam is detected in the main scanning direction. As an example, a first beam detecting apparatus 421 may be arranged at a start position at which a valid image area of an OPC drum is started and a second beam detecting apparatus 422 may be arranged at an end position at which the valid image area of the OPC drum is ended.

The image forming apparatus 100 may obtain a first detection time at which the beam is detected from a reference position 401 at which scanning of the beam with respect to a certain color is started to the position of the first beam detecting apparatus 421 of the certain color. Also, the image forming apparatus 100 may obtain a second detection time at which the beam is detected from the reference position 401 at which the scanning of the beam with respect to the certain color is started to the position of the second beam detecting apparatus 422 of the certain color.

When the lens 410 is expanded, an angle by which the beam is refracted from the lens 410 is changed. Thus, the first detection time at which the beam is detected by the first beam detecting apparatus 421 before the lens 410 is expanded and the first detection time at which the beam is detected by the first beam detecting apparatus 421 after the lens 410 is expanded may be different from each other. The image forming apparatus 100 may obtain the amount of change in the start position of the valid image area, based on the amount of change in the first detection time.

Likewise, when the lens 410 is expanded, the angle by which the beam is refracted from the lens 410 is changed and the second detection time at which the beam is detected by the second beam detecting apparatus 422 before the lens 410 is expanded and the second detection time at which the beam is detected by the second beam detecting apparatus 422 after the lens 410 is expanded may be different from each other. The image forming apparatus 100 may obtain the amount of change in the end position of the valid image area based on the amount of change of the second detection time.

The image forming apparatus 100 may obtain the amount of change of a width of the valid image area, based on the amount of change in a difference between the second detection time and the first detection time.

A degree of color distortion may be dependent upon the amount of change with respect to a parameter determining the color distortion, wherein the amount of change is different among colors. The image forming apparatus 100 may correct the color distortion based on the amount of change of the parameter with respect to a certain color against a reference color. FIGS. 5 through 7 describe an example method of detecting a position change of a beam with respect to a certain color in a main scanning direction against a reference color.

FIG. 5 is a flowchart for describing a method of detecting a position change of a beam in a main scanning direction in an image forming apparatus, according to an example.

Referring to FIG. 5, the image forming apparatus 100 may calculate an amount of change in a start position of a valid image area with respect to a certain color against a reference color in a main scanning direction in operation 510.

For example, the image forming apparatus 100 may calculate the amount of change in the start position of the valid image area with respect to the certain color against the reference color in the main scanning direction, based on the change in the detection time at which the beam is detected, from a reference position from which scanning of the beam with respect to each of the reference color and the certain color is started, to a position of a first beam detecting apparatus to detect the start position of the valid image area.

As an example, the image forming apparatus 100 may obtain a first reference detection time at which the beam is detected from the reference position at which the scanning of the beam with respect to the reference color is started to the position of the first beam detecting apparatus with respect to the reference color. Also, the image forming apparatus 100 may obtain a first detection time at which the beam is detected from the reference position at which the scanning of the beam with respect to the certain color is started to the position of the first beam detecting apparatus with respect to the certain color. The image forming apparatus 100 may calculate the amount of change of the start position of the valid image area with respect to the certain color against the reference color in the main scanning direction, based on a difference between the first detection time of the certain color and the first detection time of the reference color. Here, when there is the amount of change of the start position of the valid image area, the image forming apparatus 100 may determine that there is a distortion between the image of the reference color and the image of the certain color.

In operation 520, the image forming apparatus 100 may calculate the amount of change in the width of the valid image area with respect to the certain color against the reference color in the main scanning direction.

For example, the image forming apparatus 100 may calculate the amount of change in the width of the valid image area with respect to the certain color against the reference color in the main scanning direction, based on a change in a detection time at which the beam in the main scanning direction is detected by a first beam detecting apparatus to detect the start position of the valid image area with respect to each of the reference color and the certain color and a change in a detection time at which the beam in the main scanning direction is detected by a second beam detecting apparatus to detect an end position of the valid image area.

As an example, the image forming apparatus 100 may obtain a second reference detection time at which the beam is detected from the reference position from which the scanning of the beam with respect to the reference color is started to a position of the second beam detecting apparatus with respect to the reference color. A reference width of the valid image area with respect to the reference color may be calculated based on a difference between the second reference detection time and the first reference detection time.

Also, the image forming apparatus 100 may obtain a second detection time at which the beam is detected from the reference position at which the scanning of the beam with respect to the certain color is started to the position of the second beam detecting apparatus of the certain color. The width of the valid image area with respect to the certain color may be calculated based on a difference between the second detection time and the first detection time.

The image forming apparatus 100 may calculate the amount of change in the width of the valid image area with respect to the certain color against the reference color, by calculating a difference between the width of the valid image area with respect to the certain color and the reference width of the valid image area with respect to the reference color. Here, when there is the amount of change of the width of the valid image area, the image forming apparatus 100 may determine that there is a distortion between the image of the reference color and the image of the certain color.

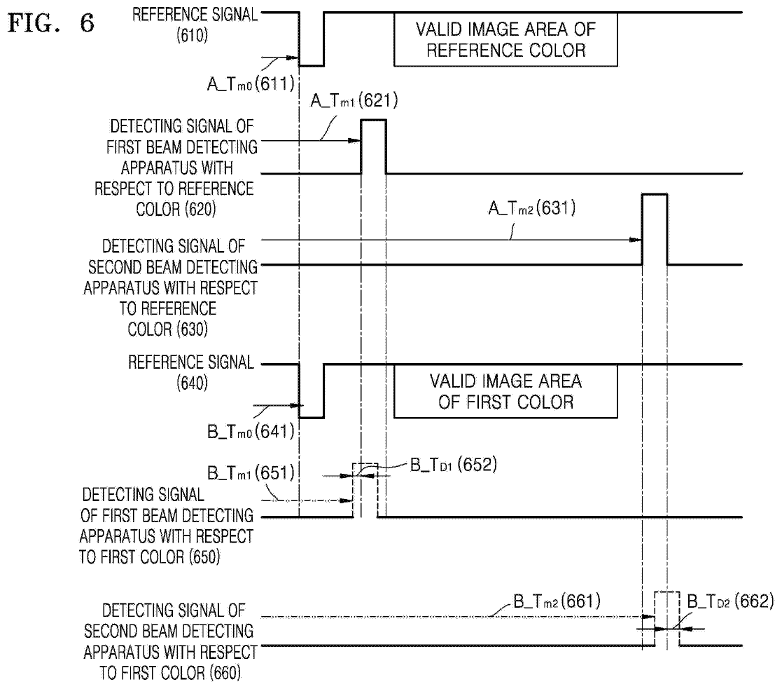

FIG. 6 is a view for describing a change in a detection time detected by a beam detecting apparatus, when a position of a beam is changed in a main scanning direction, according to an example.

Referring to FIG. 6, a first beam detecting apparatus and a second beam detecting apparatus of a reference color may be arranged at a start position and an end position of a valid image area of an OPC drum of the reference color, respectively. A direction from the start position of the valid image area to the end position area may be a main scanning direction indicating a scan direction of an image forming job.

Referring to a reference signal 610 of the reference color and a detecting signal 620 of the first beam detecting apparatus of the reference color, the image forming apparatus 100 may obtain a first reference detection time by calculating a difference between a time point A_Tₘ₀ 611 at a reference position, at which scanning of the beam with respect to the reference color is started, and a time point A_Tₘ₁ 621 at which the beam is detected at the position of the first beam detecting apparatus of the reference color.

Referring to the reference signal 610 of the reference color and a detecting signal 630 of the second beam detecting apparatus of the reference color, the image forming apparatus 100 may obtain a second reference detection time by calculating a difference between the time point A_Tₘ₀ 611 at the reference position, at which the scanning of the beam with respect to the reference color is started, and a time point A_Tₘ₂ 631 at which the beam is detected at the position of the second beam detecting apparatus of the reference color.

A first beam detecting apparatus and a second beam detecting apparatus of a first color may be arranged at a start position and an end position of a valid image area of an OPC drum of the first color, respectively.

Referring to a reference signal 640 of the first color and a detecting signal 650 of the first beam detecting apparatus of the first color, the image forming apparatus 100 may obtain a first detection time by calculating a difference between a time point B_Tₘ₀ 641 at a reference position, at which scanning of a beam with respect to the first color is started, and a time point B_Tₘ₁ 651 at which the beam is detected at the position of the first beam detecting apparatus of the first color.

Referring to the reference signal 640 of the first color and a detecting signal 660 of the second beam detecting apparatus of the first color, the image forming apparatus 100 may obtain a second detection time by calculating a difference between the time point B_Tₘ₀ 641 at the reference position, at which the scanning of the beam with respect to the first color is started, and a time point B_Tₘ₂ 661 at which the beam is detected at the position of the second beam detecting apparatus of the first color.

The image forming apparatus 100 may obtain a change amount B_T_{D1} 652 of the detection time at which the start position of the valid image area is detected, by calculating a difference between the first detection time and the first reference detection time.

The image forming apparatus 100 may obtain the amount of time change corresponding to the reference width of the valid image area with respect to the reference color, by calculating a difference between the first reference detection time and the second reference detection time. The image forming apparatus 100 may obtain the amount of time change corresponding to the width of the valid image area with respect to the first color, by calculating a difference between the first detection time and the second detection time. Also, the image forming apparatus 100 may obtain the amount of time change B_T_{D2} 662 corresponding to the amount of change of the width of the valid image area with respect to the certain color against the reference color, by calculating a difference between the amount of time change corresponding to the reference width of the reference color and the amount of time change corresponding to the width of the first color.

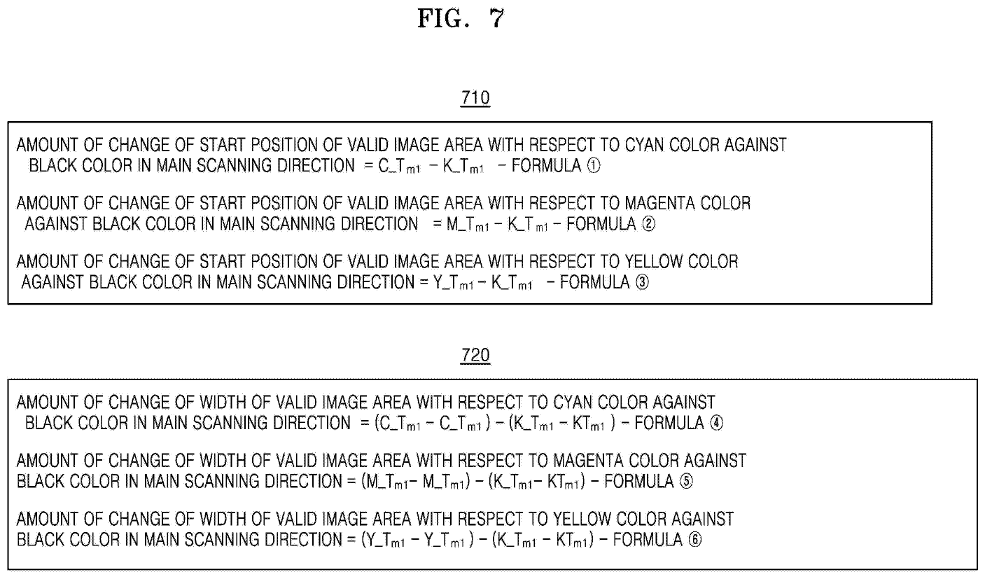

FIG. 7 is a view for describing a method of calculating an amount of change of a start position of a valid image area of a certain color against a reference color in a main scanning direction and an amount of change of a width of the valid image area, according to an example.

Referring to FIG. 7, the developing device in the image forming apparatus 100 may form images having a cyan color C, a magenta color M, a yellow color Y, and a black color K. Here, the black B color may be set as a reference color. Other colors may be set as the reference color.

Block 710 of FIG. 7 shows a formula for calculating an amount of change in a detection time at which a start position of a valid image area with respect to a certain color is detected in a main scanning direction, against a black color K. The image forming apparatus 100 may calculate the amount of change of the start position of the valid image area with respect to the certain color against the reference color in the main scanning direction, based on the amount of change of the detection time at which the start position of the valid image area is detected.

Formula \textcircled{1} of FIG. 7 indicates a method of calculating the amount of change of a detection time at which a start position of a valid image area with respect to a cyan color C is detected in the main scanning direction, against a black color K. Here, C_Tₘ₁ indicates the detection time at which the start position of the valid image area with respect to the cyan color C is detected and K_Tₘ₁ indicates the detection time at which the start position of the valid image area with respect to the black color K is detected.

Formula \textcircled{2} of FIG. 7 indicates a formula for calculating the amount of change of a detection time at which a start position of a valid image area with respect to the magenta color M is detected in the main scanning direction, against the black color K. Here, M_Tₘ₁ indicates the detection time at which the start position of the valid image area with respect to the magenta color M is detected.

Formula \textcircled{3} of FIG. 7 indicates a formula for calculating the amount of change of a detection time at which a start position of a valid image area with respect to the yellow color Y is detected in the main scanning direction, against the black color K. Here, Y_Tₘ₁ indicates the detection time at which the start position of the valid image area with respect to the yellow color Y is detected.

Block 720 of FIG. 7 indicates a formula for calculating an amount of change in a detection time at which a width of a valid image area with respect to a certain color is detected in the main scanning direction, against the black color K. The image forming apparatus 100 may calculate the amount of change of the width of the valid image area with respect to the certain color in the main scanning direction, against the reference color, based on the amount of change of the detection time at which the width of the valid image area is detected.

Formula \textcircled{4} of FIG. 7 indicates a method of calculating the amount of change of a detection time at which a width of a valid image area with respect to the cyan color C is detected in the main scanning direction, against the black color K. Here, C_Tₘ₂ indicates a detection time at which an end position of the valid image area with respect to the cyan color C is detected and K_Tₘ₂ indicates a detection time at which an end position of the valid image area with respect to the black color K is detected.

Formula \textcircled{5} of FIG. 7 indicates a method of calculating the amount of change of a detection time at which a width of a valid image area with respect to the magenta color M is detected in the main scanning direction, against the black color K. Here, M_Tₘ₂ indicates a detection time at which an end position of the valid image area with respect to the magenta color M is detected.

Formula \textcircled{6} of FIG. 7 indicates a method of calculating the amount of change of a detection time at which a width of a valid image area with respect to the yellow color Y is detected in the main scanning direction, against the black color K. Here, Y_Tₘ₂ indicates a detection time at which an end position of the valid image area with respect to the yellow color Y is detected.

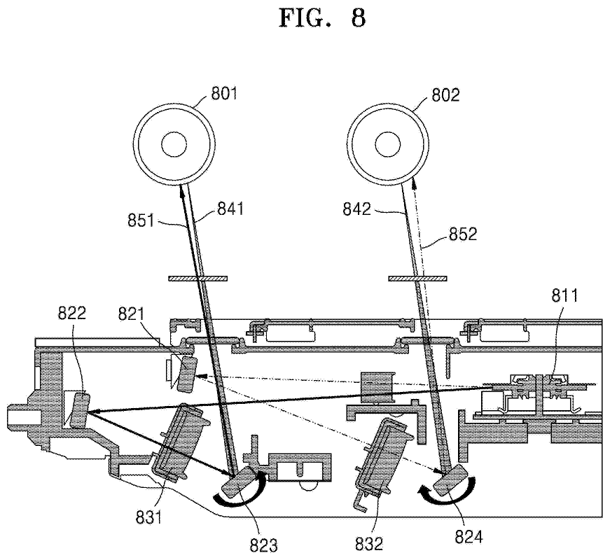

FIG. 8 is a view for describing a position of a beam, the position being changed in a sub-scanning direction according to rotation of a mirror, according to an example.

Referring to FIG. 8, according to an operation of a motor 811 in an LSU, a beam may be transmitted to OPC drums 801 and 802 through mirrors 821, 822, 823, and 824 and lenses 831 and 832. Due to a change in an external temperature, the lenses 831 and 832 in the LSU may be expanded, angles of the mirrors 821, 822, 823, and 824 may be changed, etc.

In the example of FIG. 8, the angles of mirrors 823 and 824 in the LSU may be changed due to the change in the external temperature. For example, the angle of the mirror 823 may be changed, as the mirror 823 rotates in a counterclockwise direction. Also, the angle of the mirror 824 may be changed, as the mirror 824 rotates in a clockwise direction.

When the angles of the mirrors 823 and 824 are changed due to the change in the external temperature, the position of the beam may be changed to a forward position 851 or a rearward position 852 with respect to previous positions 841 and 842 of the beam, in the sub-scanning direction.

FIG. 9 is a flowchart for describing a method of detecting a position change of a beam in a sub-scanning direction, in an image forming apparatus, according to an example.

Referring to FIG. 9, the image forming apparatus 100 may calculate an amount of change in a start position of a valid image area with respect to a certain color in a sub-scanning direction, against a reference color in operation 910.

For example, the image forming apparatus 100 may calculate the amount of change of the start position of the valid image area with respect to the certain color in the sub-scanning direction, against the reference color, based on a change of a detection time at which a beam is detected from a pixel data read trigger signal with respect to each of the reference color and the certain color.

As an example, the image forming apparatus 100 may obtain a third reference detection time at which the beam is detected from the pixel data read trigger signal with respect to the reference color. Also, the image forming apparatus 100 may obtain a third detection time at which the beam is detected from the pixel data read trigger signal with respect to the certain color. The image forming apparatus 100 may calculate the amount of change of the start position of the valid image area with respect to the certain color in the sub-scanning direction, against the reference color, based on a difference between the third detection time of the certain color and the third reference detection time of the reference color. Here, when there is the amount of change of the start position of the valid image area, the image forming apparatus 100 may determine that there is a distortion between an image of the reference color and an image of the certain color.

In operation 920, the image forming apparatus 100 may calculate the amount of change in the distortion of the valid image area with respect to the certain color in the sub-scanning direction, against the reference color.

For example, the image forming apparatus 100 may calculate the amount of change in the distortion of the valid image area with respect to the certain color in the sub-scanning direction, against the reference color, based on a change in a detection time at which the beam in the sub-scanning direction is detected by a first beam detecting apparatus to detect the start position of the valid image area with respect to each of the reference color and the certain color and a change in a detection time at which the beam in the sub-scanning direction is detected by a second beam detecting apparatus to detect an end position of the valid image area.

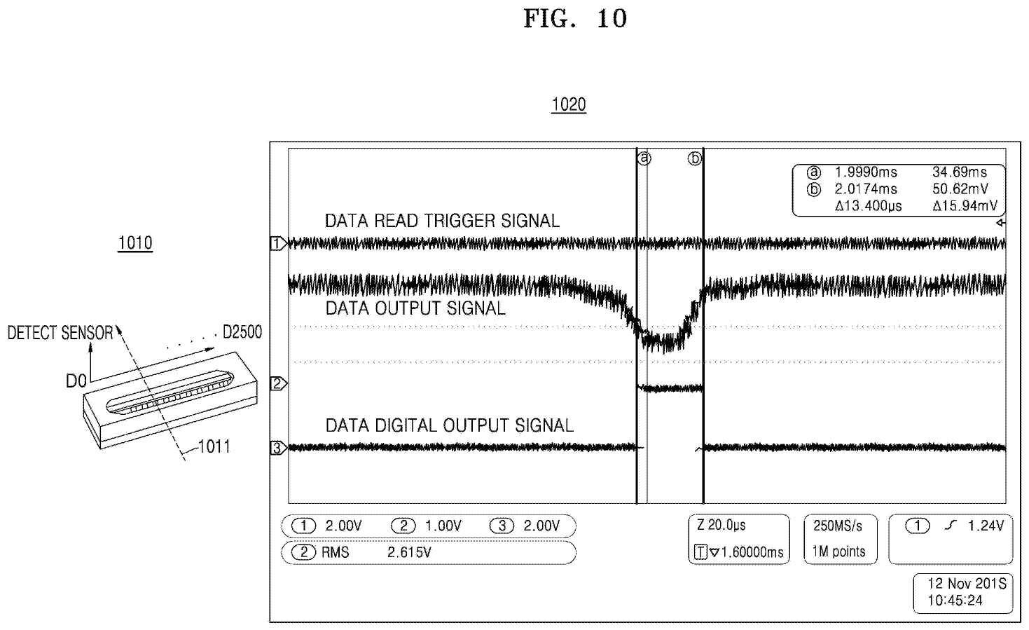

FIG. 10 is a view for describing a beam detecting apparatus to detect a beam in a sub-scanning direction and an output signal of the beam detecting apparatus, according to an example.

Referring to FIG. 10, an image 1010 illustrates a sensor to detect the beam in a sub-scanning direction indicating a progress direction of an image forming job. The sub-scanning direction may be perpendicular to a main scanning direction 1011. Here, the sensor to detect the beam in the sub-scanning direction may include a PD sensor, a linear CCD sensor, or the like.

As illustrated in the image 1010 of FIG. 10, pixels having a constant size may be arranged in the sensor, (e.g., a linear CCD sensor).

Referring to a graph 1020 of FIG. 10, the image forming apparatus 100 may output a data output signal in response to a data read trigger signal. A data digital output signal may be a signal generated by converting the data output signal into a digital signal.

For example, the image forming apparatus 100 may detect a central point of a rising edge and a falling edge and a central point of a falling edge and a rising edge and may determine a position of a pixel, the position corresponding to the central point, as a position in which the beam is detected.

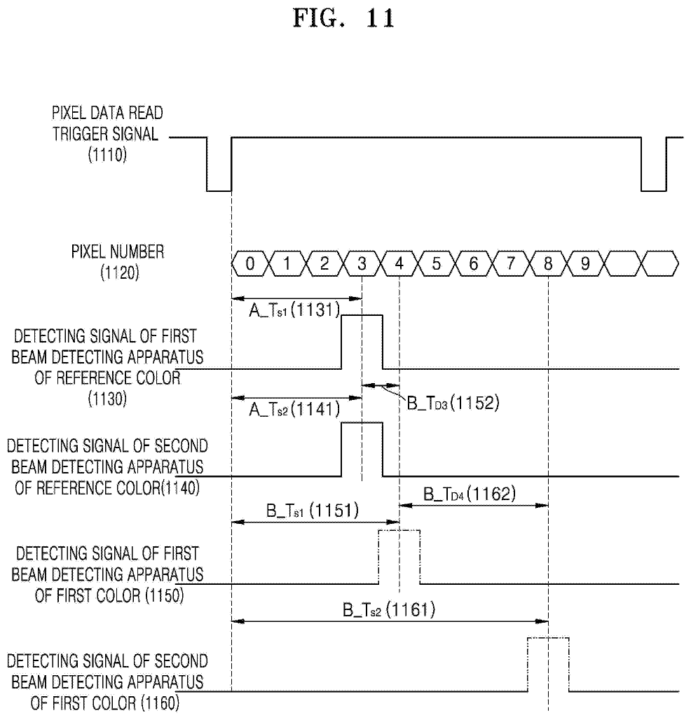

FIG. 11 is a view for describing a change in a detection time detected by a beam detecting apparatus, when a position of a beam is changed in a sub-scanning direction, according to an example.

Referring to FIG. 11, a first beam detecting apparatus and a second beam detecting apparatus of a reference color may be arranged at a start position and an end position of a valid image area of an OPC drum of the reference color, respectively.

Referring to a pixel data read trigger signal 1110 and a detecting signal 1130 of the first beam detecting apparatus of the reference color, the image forming apparatus 100 may obtain a third reference detection time at which the beam in the sub-scanning direction is detected by the first beam detecting apparatus of the reference color. The image forming apparatus 100 may determine a time at a central point of a rising edge and a falling edge in the detecting signal 1130 as the third reference detection time. The third reference detection time may be A_Tₛ₁ 1131. The image forming apparatus 100 may obtain the start position of the valid image area of the reference color from a position of a pixel corresponding to the central point of the rising edge and the falling edge in the detecting signal 1130. Referring to a pixel number 1120, the pixel corresponding to the central point may be a third pixel.

Referring to the pixel data read trigger signal 1110 and a detecting signal 1140 of the second beam detecting apparatus of the reference color, the image forming apparatus 100 may obtain a fourth reference detection time at which the beam in the sub-scanning direction is detected by the second beam detecting apparatus of the reference color. The image forming apparatus 100 may determine a time at a central point of a rising edge and a falling edge in the detecting signal 1140 as the fourth reference detection time. The fourth reference detection time may be A_Tₛ₂ 1141. The image forming apparatus 100 may obtain the end position of the valid image area of the reference color from a position of a pixel corresponding to the central point of the rising edge and the falling edge in the detecting signal 1140. Referring to the pixel number 1120, the pixel corresponding to the central point may be the third pixel.

A first beam detecting apparatus and a second beam detecting apparatus of a first color may be arranged at a start position and an end position of a valid image area of an OPC drum of the first color, respectively.

Referring to the pixel data read trigger signal 1110 and a detecting signal 1150 of the first beam detecting apparatus of the first color, the image forming apparatus 100 may obtain a third detection time at which the beam in the sub-scanning direction is detected by the first beam detecting apparatus of the first color. The image forming apparatus 100 may determine a time at a central point of a rising edge and a falling edge in the detecting signal 1150 as the third detection time. The third detection time may be B_Tₛ₁ 1151. The image forming apparatus 100 may obtain the start position of the valid image area of the first color from a position of a pixel corresponding to the central point of the rising edge and the falling edge in the detecting signal 1150. Referring to the pixel number 1120, the pixel corresponding to the central point may be a fourth pixel.

Referring to the pixel data read trigger signal 1110 and a detecting signal 1160 of the second beam detecting apparatus of the first color, the image forming apparatus 100 may obtain a fourth detection time at which the beam in the sub-scanning direction is detected by the second beam detecting apparatus of the first color. The image forming apparatus 100 may determine a time at a central point of a rising edge and a falling edge in the detecting signal 1160 as the fourth detection time. The fourth detection time may be B_Tₛ₂ 1161. The image forming apparatus 100 may obtain the end position of the valid image area of the first color from a position of a pixel corresponding to the central point of the rising edge and the falling edge in the detecting signal 1160. Referring to the pixel number 1120, the pixel corresponding to the central point may be an eighth pixel.

For example, the image forming apparatus 100 may obtain a change amount B_T_{D3} 1152 of the detection time by calculating a difference between the third detection time and the third reference detection time. The image forming apparatus 100 may calculate the amount of change in the start position of the valid image area with respect to the first color against the reference color in the sub-scanning direction, based on the change amount B_T_{D3} 1152 of the detection time.

For example, the image forming apparatus 100 may obtain a change amount B_T_{D4} 1162 of the detection time by calculating a difference between the third detection time and the fourth detection time. The image forming apparatus 100 may calculate the amount of change in distortion of the first color in the sub-scanning direction, based on the change amount B_T_{D4} 1162 of the detection time.

For example, the image forming apparatus 100 may obtain a change amount of the detection time by calculating a difference between the third reference detection time and the fourth reference detection time. The image forming apparatus 100 may calculate the amount of change in distortion of the reference color in the sub-scanning direction, based on the change amount of the detection time. Here, when the change amount of the detection time is 0, the image forming apparatus 100 may determine that there is no distortion of the reference color in the sub-scanning direction.

For example, the image forming apparatus 100 may obtain a change amount of the detection time by calculating a difference between the fourth detection time and the fourth reference detection time. The image forming apparatus 100 may calculate the amount of change in the end position of the valid image area with respect to the first color against the reference color in the sub-scanning direction, based on the change amount of the detection time.

For example, the image forming apparatus 100 may calculate the amount of change in the distortion of the valid image area with respect to the first color against the reference color in the sub-scanning direction, based on a difference between the amount of change in the start position of the valid image area with respect to the first color against the reference color in the sub-scanning direction and the amount of change in the end position of the valid image area with respect to the first color against the reference color in the sub-scanning direction.

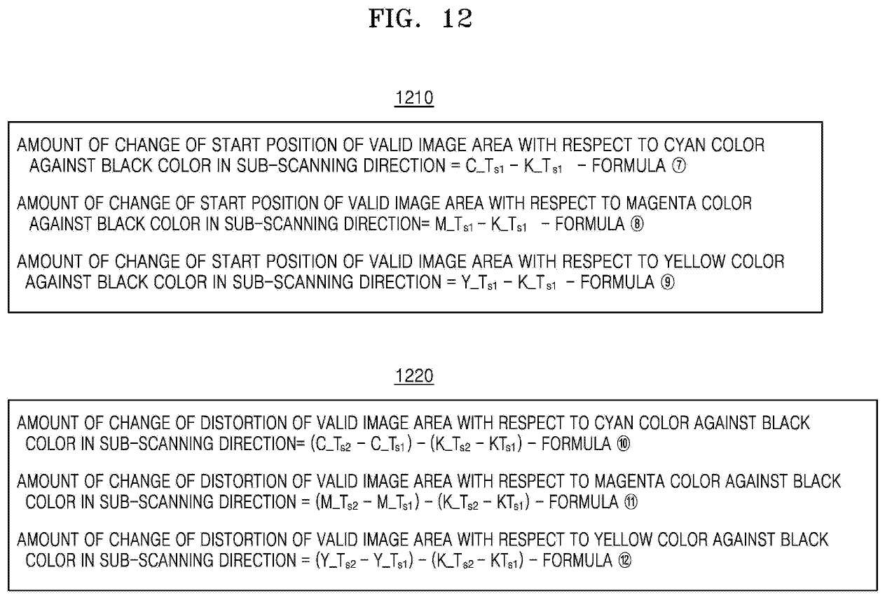

FIG. 12 is a view for describing a method of calculating an amount of change of a start position of a valid image area of a certain color against a reference color in a sub-scanning direction and an amount of change of distortion of the valid image area of the certain color against the reference color, according to an example.

Referring to FIG. 12, a developing device in the image forming apparatus 100 may form images having a cyan color C, a magenta color M, a yellow color Y, and a black color K. Here, the black color K may be set as the reference color. Other colors may be set as the reference color.

Block 1210 of FIG. 12 indicates a formula for calculating an amount of change in a detection time at which a start position of a valid image area with respect to a certain color is detected in a sub-scanning direction, against the black color K. The image forming apparatus 100 may calculate the amount of change of the start position of the valid image area with respect to the certain color against the reference color in the sub-scanning direction, based on the amount of change of the detection time at which the start position of the valid image area is detected.

Formula \textcircled{7} of FIG. 12 indicates a method of calculating an amount of change of a detection time at which a start position of a valid image area with respect to the cyan color C is detected in the sub-scanning direction, against the black color K. Here, C_Tₛ₁ indicates a detection time at which the start position of the valid image area with respect to the cyan color C is detected and K_Tₛ₁ indicates a detection time at which the start position of the valid image area with respect to the black color K is detected.

Formula \textcircled{8} of FIG. 12 indicates a formula for calculating an amount of change of a detection time at which a start position of a valid image area with respect to the magenta color M is detected in the sub-scanning direction, against the black color K. Here, M_Tₛ₁ indicates a detection time at which the start position of the valid image area with respect to the magenta color M is detected.

Formula \textcircled{9} of FIG. 12 indicates a formula for calculating an amount of change of a detection time at which a start position of a valid image area with respect to the yellow color Y is detected in the sub-scanning direction, against the black color K. Here, Y_Tₛ₁ indicates a detection time at which the start position of the valid image area with respect to the yellow color Y is detected.

Block 1220 of FIG. 12 indicates a formula for calculating an amount of change in a detection time indicating distortion of a valid image area with respect to a certain color in the sub-scanning direction, against the black color K. The image forming apparatus 100 may calculate an amount of change in distortion of a valid image area with respect to a first color against a reference color in the sub-scanning direction, based on a difference between the amount of change in a detection time at which a start position of a valid image area with respect to the first color is detected in the sub-scanning direction, against a reference color, and an amount of change in a detection time at which an end position of the valid image area with respect to the first color is directed in the sub-scanning direction, against the reference color.

Formula \textcircled{10} of FIG. 12 indicates a formula for calculating an amount of change in a detection time indicating distortion of a valid image area with respect to the cyan color C against the black color K in the sub-scanning direction. Here, C_Tₛ₂ indicates a detection time at which an end position of the valid image area with respect to the cyan color C is detected and K_Tₛ₂ indicates a detection time at which an end position of the valid image area with respect to the black color K is detected.

Formula \textcircled{11} of FIG. 12 indicates a formula for calculating an amount of change in a detection time indicating distortion of a valid image area with respect to the magenta color M against the black color K in the sub-scanning direction. Here, M_Tₛ₂ indicates a detection time at which an end position of the valid image area with respect to the magenta color M is detected.

Formula \textcircled{12} of FIG. 12 indicates a formula for calculating the amount of change in a detection time indicating distortion of a valid image area with respect to the yellow color Y against the black color K in the sub-scanning direction. Here, Y_Tₛ₂ indicates a detection time at which an end position of the valid image area with respect to the yellow color Y is detected.

FIG. 13 is a block diagram illustrating a structure of an image forming apparatus, according to an example.

Referring to FIG. 13, an image forming apparatus 1300 may include a diode 1310, a beam detecting apparatus 1320, a memory 1330, and a processor 1340. However, not all illustrated components are essential components. The image forming apparatus 1300 may be realized by including more or fewer components than the illustrated components. Hereinafter, the components described above will be described. The image forming apparatus 1300 of FIG. 13 may correspond to the image forming apparatus 100 of FIG. 1.

The diode 1310 may irradiate a beam used for an image forming job. The diode 1310 may be included in an LSU of the image forming apparatus 1300. The beam detecting apparatus 1320 may detect a beam in a main scanning direction and a beam in a sub-scanning direction of the image forming job. Here, the main scanning direction may indicate a scan direction of the image forming job and the sub-scanning direction may indicate a progress direction of the image forming job.

The beam detecting apparatus 1320 may include a first sensor to detect the beam in the main scanning direction and a second sensor to detect the beam in the sub-scanning direction. For example, each of the first sensor and the second sensor may include a PD sensor, a linear CCD sensor, or the like.

The beam detecting apparatus 1320 may be arranged between each of arrays of OPC drums with respect to a plurality of colors and the LSU. Also, the beam detecting apparatus 1320 may be arranged at each of a start position and an end position of a valid image area of each of the OPC drums. Here, the start position of the valid image area may be the right side based on the sub-scanning direction and the end position of the valid image area may be the left side based on the sub-scanning direction. The beam detecting apparatus 1320 may be arranged at an outer edge around the valid image area of each of the OPC drums.

The memory 1330 may store programs, data, or files related to the image forming apparatus 1300. The processor 1340 may execute the programs stored in the memory 1330, read the data or files stored in the memory 1330, or store new files in the memory 1330. The memory 1330 may store program commands, data files, data structures, etc. singularly or in a combined way. The memory 1330 may store instructions executable by the processor 1340.

The processor 1340 may control an operation of the image forming apparatus 1300 and may include at least one processor, such as a central processing unit (CPU). The processor 1340 may include at least one specialized processor corresponding to each function or may be an integrated-type processor.

The processor 1340 may detect a position change of a beam with respect to a certain color in the main scanning direction, based on a change in a detection time at which the beam with respect to the certain color is detected by the beam detecting apparatus 1320 in the main scanning direction, against a reference color.

For example, the processor 1340 may calculate the amount of change of a start position of a valid image area with respect to the certain color against the reference color in the main scanning direction and the amount of change of a width of the valid image area, based on a change in the detection time at which the beam is detected in the main scanning direction.

The processor 1340 may calculate the amount of change in the start position of the valid image area with respect to the certain color against the reference color in the main scanning direction, based on a change in a detection time at which the beam is detected, from a reference position from which scanning of the beam with respect to each of the reference color and the certain color is started, to a position of the first beam detecting apparatus to detect the start position of the valid image area.

The processor 1340 may calculate the amount of change in the width of the valid image area with respect to the certain color against the reference color in the main scanning direction, based on a change in a detection time at which the beam is detected in the main scanning direction by the first beam detecting apparatus to detect the start position of the valid image area with respect to each of the reference color and the certain color, and a change in a detection time at which the beam is detected in the main scanning direction by the second beam detecting apparatus to detect an end position of the valid image area with respect to each of the reference color and the certain color.

The processor 1340 may detect a position change of the beam with respect to a certain color in the sub-scanning direction, based on the change in the detection time at which the beam with respect to the certain color is detected by the beam detecting apparatus 1320 in the sub-scanning direction, against the reference color.

For example, the processor 1340 may calculate the amount of change in the start position of the valid image area with respect to the certain color against the reference color in the sub-scanning direction, and the amount of change in distortion of the valid image area, based on the change in the detection time at which the beam is detected in the sub-scanning direction.

The processor 1340 may calculate the amount of change in the start position of the valid image area with respect to the certain color against the reference color in the sub-scanning direction, based on a change in a detection time at which the beam is detected from a pixel data read trigger signal with respect to each of the reference color and the certain color.

The processor 1340 may calculate the amount of change in distortion of the valid image area with respect to the certain color against the reference color in the sub-scanning direction, based on a change in a detection time at which the beam is detected in the sub-scanning direction by the beam detecting apparatus 1320 to detect the start position of the valid image area with respect to each of the reference color and the certain color and a change in a detection time at which the beam is detected in the sub-scanning direction by the second beam detecting apparatus to detect an end position of the valid image area with respect to each of the reference color and the certain color.

The processor 1340 may correct a value of at least one parameter used to perform alignment between an image of the reference color and an image of the certain color, based on the position changes of the beam with respect to the certain color in the main scanning direction and the sub-scanning direction.

For example, the processor 1340 may correct at least one value of a scan time point of the beam, a frequency of the beam, or an angle of a lens transmitting the beam to an OPC drum, based on the position changes of the beam with respect to the certain color in the main scanning direction and the sub-scanning direction.

For example, when the start position of the valid image area is changed because the position of the beam is changed in the main scanning direction or the sub-scanning direction, the processor 1340 may adjust the scan time point of the beam to make the start positions of the valid image areas with respect to colors correspond to one another.

For example, when the width of the valid image area is changed because the position of the beam is changed in the main scanning direction, the processor 1340 may adjust the frequency of the beam based on the amount of change in the width of the valid image area, to make the widths of the valid image areas with respect to the colors correspond to one another.

For example, when distortion occurs in the valid image area because the position of the beam is changed in the sub-scanning direction, the processor 1340 may adjust the angle of the lens based on the amount of change in the distortion of the valid image area, to align images with respect to the colors.

The processor 1340 may obtain an initial value of at least one parameter used to align the position of the beam or an image having a plurality of colors aligned, in a state in which the image is generated. The memory 1330 may store the initial value of the at least one parameter corresponding to the state in which the image having the plurality of colors aligned is generated. The processor 1340 may correct a value of the at least one parameter based on distortion among the colors and the initial value of the at least one parameter.

The operating method of the image forming apparatuses 100 and 1300 described above may be implemented by a non-transitory computer-readable recording medium storing instructions or data executable by a computer or a processor. The operating method of the image forming apparatuses 100 and 1300 may be written as a program executable by a computer and may be implemented by a general-purpose digital computer to operate the program by using a computer-readable recording medium. The computer-readable recording medium may include read-only memory (ROM), random-access memory (RAM), flash memory, CD-ROMs, CD−Rs, CD+Rs, CD−RWs, CD+RWs, DVD-ROMs, DVD−Rs, DVD+Rs, DVD−RWs, DVD+RWs, DVD-RAMs, BD-ROMs, BD-Rs, BD-R LTHs, BD-REs, a magnetic tape, a floppy disk, a magneto-optic data storage device, an optical data storage device, a hard disk, a solid-state disk (SSD), and any other device capable of storing instructions or software, related data, data files, and data structures and providing the instructions, software, related data, data files, and data structures to a processor or a computer so that the processor or the computer execute the same.

While the examples have been particularly shown and described with reference to examples thereof and the drawings, it will be understood by one of ordinary skill in the art that various changes and modifications may be made based on the descriptions. For example, appropriate results may be accomplished when the described techniques are executed in different orders from the methods described above, and/or the described components, such as the system, structure, device, circuit, etc., are combined or assembled in different forms from the methods described above, or replaced or substituted by other components or equivalents. Therefore, the scope of the disclosure is indicated by the following claims and equivalents of the claims and should not be construed as limited to the examples described herein.

What is claimed is:

1. An operating method of an image forming apparatus, the operating method comprising:
detecting a position change of a beam with respect to a certain color in a main scanning direction, based on a change in a detection time at which the beam with respect to the certain color is detected against a reference color by a beam detecting apparatus in the image forming apparatus in the main scanning direction;
detecting a position change of the beam with respect to the certain color in a sub-scanning direction, based on a change in a detection time at which the beam with respect to the certain color is detected against the reference color by the beam detecting apparatus in the sub-scanning direction; and
correcting a value of at least one parameter used for alignment between an image of the reference color and an image of the certain color, based on the position changes of the beam with respect to the certain color in the main scanning direction and the sub-scanning direction.

2. The operating method of claim 1, wherein the detecting of the position change of the beam with respect to the certain color in the main scanning direction comprises calculating a change amount of a start position of a valid image area with respect to the certain color against the reference color in the main scanning direction and a change amount of a width of the valid image area with respect to the certain color against the reference color in the main scanning direction, based on a change in the detection time at which the beam is detected in the main scanning direction.

3. The operating method of claim 2, wherein the calculating of the change amount of the start position of the valid image area with respect to the certain color against the reference color in the main scanning direction comprises calculating the change amount of the start position of the valid image area with respect to the certain color against the reference color in the main scanning direction, based on the change in the detection time at which the beam is detected, from a reference position at which scanning of the beam with respect to each of the reference color and the certain color is started to a position of a first beam detecting apparatus to detect the start position of the valid image area.

4. The operating method of claim 2, wherein the calculating of the change amount of the width of the valid image area with respect to the certain color against the reference color in the main scanning direction comprises calculating the change amount of the width of the valid image area with respect to the certain color against the reference color in the main scanning direction, based on a change in a detection time at which the beam in the main scanning direction is detected by a first beam detecting apparatus to detect the start position of the valid image area with respect to each of the reference color and the certain color and a change in a detection time at which the beam in the main scanning direction is detected by a second beam detecting apparatus to detect an end position of the valid image area with respect to each of the reference color and the certain color.

5. The operating method of claim 1, wherein the detecting of the position change of the beam with respect to the certain color in the sub-scanning direction comprises calculating a change amount of a start position of a valid image area with respect to the certain color against the reference color in the sub-scanning direction and a change amount of a distortion of the valid image area with respect to the certain color against the reference color in the sub-scanning direction, based on the change in the detection time at which the beam is detected in the sub-scanning direction.

6. The operating method of claim 5, wherein the calculating of the change amount of the start position of the valid image area with respect to the certain color against the reference color in the sub-scanning direction comprises calculating the change amount of the start position of the valid image area with respect to the certain color against the reference color in the sub-scanning direction, based on a change in a detection time at which the beam is detected from a pixel data read trigger signal with respect to each of the reference color and the certain color.

7. The operating method of claim 5, wherein the calculating of the change amount of the distortion of the valid image area with respect to the certain color against the reference color in the sub-scanning direction comprises calculating the change amount of the distortion of the valid image area with respect to the certain color against the reference color in the sub-scanning direction, based on a change in a detection time at which the beam in the sub-scanning direction is detected by a first beam detecting apparatus to detect a start position of the valid image area with respect to each of the reference color and the certain color and a change in a detection time at which the beam in the sub-scanning direction is detected by a second beam detecting apparatus to detect an end position of the valid image area with respect to each of the reference color and the certain color.

8. The operating method of claim 1,
wherein the main scanning direction indicates a scan direction of an image forming job, and
wherein the sub-scanning direction indicates a progress direction of the image forming job.

9. The operating method of claim 1, wherein the correcting of the value of the at least one parameter used for the alignment between the image of the reference color and the image of the certain color comprises correcting at least one of a scan time point of the beam, a frequency of the beam, or an angle of a lens to transmit the beam to an organic photoconductor (OPC) drum, based on the position changes of the beam with respect to the certain color in the main scanning direction and the sub-scanning direction.

10. A non-transitory computer-readable recording medium having stored therein instructions executable by a processor, the non-transitory computer-readable recording medium comprising:
instructions to detect a position change of a beam with respect to a certain color in a main scanning direction, based on a change in a detection time at which the beam with respect to the certain color is detected against a reference color by a beam detecting apparatus in the image forming apparatus in the main scanning direction;
instructions to detect a position change of the beam with respect to the certain color in a sub-scanning direction, based on a change in a detection time at which the beam with respect to the certain color is detected against the reference color by the beam detecting apparatus in the sub-scanning direction; and
instructions to correct a value of at least one parameter used for alignment between an image of the reference color and an image of the certain color, based on the position changes of the beam with respect to the certain color in the main scanning direction and the sub-scanning direction.

11. An image forming apparatus comprising:
a diode to irradiate a beam used in an image forming job;
a beam detecting apparatus to detect a beam in a main scanning direction indicating a scan direction of the image forming job and to detect a beam in a sub-scanning direction indicating a progress direction of the image forming job;
a processor; and
a memory storing instructions executable by the processor,
wherein the processor executes the instructions to:
detect a position change of a beam with respect to a certain color in the main scanning direction, based on a change in a detection time at which the beam with respect to the certain color is detected against a reference color by the beam detecting apparatus in the main scanning direction;
detect a position change of the beam with respect to the certain color in the sub-scanning direction, based on a change in a detection time at which the beam with respect to the certain color is detected against the reference color by the beam detecting apparatus in the sub-scanning direction; and
correct a value of at least one parameter used for alignment between an image of the reference color and an image of the certain color, based on the position changes of the beam with respect to the certain color in the main scanning direction and the sub-scanning direction.

12. The image forming apparatus of claim 11, wherein the processor executes the instructions to calculate a change amount of a start position of a valid image area with respect to the certain color against the reference color in the main scanning direction and a change amount of a width of the valid image area with respect to the certain color against the reference color in the main direction, based on the change in the detection time at which the beam is detected in the main scanning direction.

13. The image forming apparatus of claim 11, wherein the processor executes the instructions to calculate a change amount of a start position of a valid image area with respect to the certain color against the reference color in the sub-scanning direction and a change amount of a distortion of the valid image area with respect to the certain color against the reference color in the sub-scanning direction, based on the change in the detection time at which the beam is detected in the sub-scanning direction.

14. The image forming apparatus of claim 11, wherein the beam detecting apparatus further comprises a first sensor to detect the beam in the main scanning direction indicating the scan direction of the image forming job and a second sensor to detect the beam in the sub-scanning direction indicating the progress direction of the image forming job.

15. The image forming apparatus of claim 11,
wherein the beam detecting apparatus is arranged between each of arrays of organic photoconductor (OPC) drums with respect to a plurality of colors and a laser scan unit, and
wherein the beam detecting apparatus is arranged at each of a start position and an end position of a valid image area of each of the OPC drums.
